(19) United States
(12) Patent Application Publication
(10) Pub. No.: US 2020/0000125 A1
(43) Pub. Date: Jan. 2, 2020

(54) Functional drink and method for preparing the same

(71) Applicant: Fuzhou RenLiang Biological Product Co., Ltd., Fuzhou (CN)

(72) Inventor: Lanqin Yang, Fuzhou (CN)

(73) Assignee: Fuzhou RenLiang Biological Product Co., Ltd.

(21) Appl. No.: 16/565,529

(22) Filed: Sep. 10, 2019

(51) Int. Cl. A23L 2/52; A23L 33/105; A23L 33/175; A23L 33/125

(52) U.S. Cl. CPC A23L 2/52; A23L 33/125; A23L 33/175; A23L 33/105

(57) ABSTRACT

The present invention discloses the functional drink and method for preparing the same, which is made of raw materials with the following weight ratios: Amino Acid of 18%˜22%, Ganoderma Lucidum of 18%˜25%, Fructo-oligosaccharide of 6%˜8% and water of 45%˜58%; this present invention will work together all over the body by exerting the differential and synergistic effect of various components and strengthen the effect of delaying senility by using Ganoderma Lucidum as the main material; the whole process of the invention is carried out under sterile environment, which makes that the finished product is safe and sanitary and the invention has the characteristics of delaying senility, safety and sanitation.

### TECHNICAL FIELD

This invention relates to technical field and more particularly relates to.

### BACKGROUND OF THE INVENTION

Nowadays, the society has been aging gradually, and senile diseases are increasing day by day. Therefore, it has become an important issue worldwide to explore ways to delay senility and improve the life quality of the elderly. A large amount of domestic and foreign data studies show that, through modern clinical and experimental studies, the action mechanism of Chinese traditional medicine for anti-senility can be divided into delaying cell senility, anti-oxidation, scavenging free radicals and regulating immune function, endocrine function, energy metabolism and DNA repair ability, and regulating the level of trace elements in the body etc.

Most studies of medicines delaying senility among the current technology focus on the senility index only and don't exert enough observation on the influence of degenerative senile disease and there is no effects.

Therefore, how to provide the functional drink and method for preparing the same is a problem to be solved by those skilled in the art.

### SUMMARY OF THE INVENTION

In view of this, the present invention provides the functional drink and method for preparing the same.

In order to achieve the above object, the present invention provides the following technical solutions: it is made of main raw materials with the following weight ratios: Amino Acid of 18%˜22%, Ganoderma Lucidum of 18%˜25%, Fructo-oligosaccharide of 6%˜8% and water of 45%˜58%.

Preferably, in the above-mentioned functional drink and method for preparing the same, the steps are as follows:

S1: Pretreating water and Amino Acid to obtain purified water and treated Amino Acid;

S2: Putting Ganoderma Lucidum into the glass bottle for cultivation and obtaining Ganoderma Lucidum extracts after extracting;

S3: Obtaining mixed liquids after mixing the purified water, treated Amino Acid and Ganoderma Lucidum extracts;

S4: Adding Fructo-oligosaccharide into the mixed liquids after stationary reaction and obtaining semi-finished product after bending;

S5: Obtaining finished product after filling, sealing, sterilization and qualified inspection.

Preferably, in the above-mentioned functional drink and method for preparing the same, the mentioned sterilization is going on under a environment that the temperature is 120° C.

According to the above technical solutions, compared with the current art, the present invention discloses the functional drink and method for preparing the same; this present invention will work together all over the body by exerting the differential and synergistic effect of various components and strengthen the effect of delaying senility by using Ganoderma Lucidum as the main material; the whole process of the invention is carried out under sterile environment, which makes that the finished product is safe and sanitary and the invention has the characteristics of delaying senility, safety and sanitation.

### DETAILED DESCRIPTION

The technical solutions in the embodiments of the present invention are clearly and completely described in the following with reference to the embodiments of the present invention. It is obvious that the described embodiments are only a part of the embodiments of the present invention, but not all embodiments. Based on the embodiments of the present invention, all other embodiments obtained by those skilled in the art without creative efforts are within the protective scope of the present invention.

Please refer to the functional drink and method for preparing the same disclosed in the invention.

The invention is made of raw materials with the following weight ratios: Amino Acid of 18%˜22%, Ganoderma Lucidum of 18%˜25%, Fructo-oligosaccharide of 6%˜8% and water of 45%˜58%.

In order to further optimize the above mentioned technical solutions, its preparation method is as follows:

S1: Pretreating water and Amino Acid to obtain purified water and treated Amino Acid;

S2: Putting Ganoderma Lucidum into the glass bottle for cultivation and obtaining Ganoderma Lucidum extracts after extracting;

S3: Obtaining mixed liquids after mixing the purified water, treated Amino Acid and Ganoderma Lucidum extracts;

S4: Adding Fructo-oligosaccharide into the mixed liquids after stationary reaction and obtaining semi-finished product after bending;

S5: Obtaining finished product after filling, sealing, sterilization and qualified inspection.

In order to further optimize the above mentioned technical solutions, the sterilization thereof is going on under a environment that the temperature is 120° C.

The various embodiments in this specification is described in a progressive manner, and each embodiment focuses on differences from other embodiments, and the same and similar parts of the various embodiments may be referred to each other. For the device disclosed in the embodiments, since it corresponds to the method disclosed in the embodiments, description is relatively simple and relative parts can be referred to the specification of method part.

The above mentioned description of disclosed embodiments enable those skilled in the art to implement or use the invention. Various modifications to these embodiments are obvious to those skilled in the art and the general disciplines defined herein may be implemented in other embodiments without departing from the spirit or scope of the invention. Therefore, the invention will not be limited to the embodiments shown herein, but applies to the widest extent consistent with the disciplines and novel features disclosed herein.

1. The functional drink and method for preparing the same, which is characterized in that it is made of raw materials with the following weight ratios: Amino Acid of 18%˜22%, Ganoderma Lucidum of 18%˜25%, Fructo-oligosaccharide of 6%˜8% and water of 45%˜58%.

2. The functional drink and method for preparing the same as per mentioned in claims 1, the steps are as follows:
S1: Pretreating water and Amino Acid to obtain purified water and treated Amino Acid;
S2: Putting Ganoderma Lucidum into the glass bottle for cultivation and obtaining Ganoderma Lucidum extracts after extracting;
S3: Obtaining mixed liquids after mixing the purified water, treated Amino Acid and Ganoderma Lucidum extracts;
S4: Adding Fructo-oligosaccharide into the mixed liquids after stationary reaction and obtaining semi-finished product after bending;
S5: Obtaining finished product after filling, sealing, sterilization and qualified inspection.

3. The functional drink and method for preparing the same as per mentioned in claims 2, which is characterized in that the mentioned sterilization is going on under a environment that the temperature is 120° C.
